(19) United States
(12) Patent Application Publication
(10) Pub. No.: US 2004/0241575 A1
(43) Pub. Date: Dec. 2, 2004

(54) Optical disk and method and apparatus for manufacturing the same

(75) Inventor: Yasuaki Ootera, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/804,100

(22) Filed: Mar. 19, 2004

(30) Foreign Application Priority Data
May 28, 2003 (JP) 2003-150978

(51) Int. Cl. G11B 7/24; B29D 17/00

(52) U.S. Cl. 430/270.1; 430/270.12; 430/321; 264/1.33

(57) ABSTRACT

An optical disk includes a first substrate having a surface which is formed to have pits representing information, and on which a reflection film is formed, and a second substrate which is light-transmissive and has a surface formed to have pits representing information, and on which a translucent film is formed of silver or sliver alloy containing silver as a main ingredient. The reflection film and the translucent film are located opposite to each other, and an intermediate layer is light-transmissive fills a gap between the reflection film and the translucent film.

### CROSS-REFERENCE TO RELATED APPLICATIONS

This application is based upon and claims the benefit of priority from prior Japanese Patent Application No. 2003-150978, filed May 28, 2003, the entire contents of which are incorporated herein by reference.

### BACKGROUND OF THE INVENTION

1. Field of the Invention

The present invention relates to a dual-layer optical disk-ROM which includes two information recorded layers, and allows the information to be read from one side of the disk with a laser beam.

2. Description of the Related Art

As a method of increasing the capacity of an optical disk, a method of using dual layers is provided. Particularly, as disk-ROMs, e.g., DVD-ROMs, single sided dual-layer disks have been generally manufactured and used, since the disk-ROMs each have a simple structure, and also a method of manufacturing the disks is simple.

The single sided dual-layer disk needs to have two reflection films, and one of them which is closer to an optical pickup head for reproducing information needs to be formed as a translucent film. However, in a conventional dual-layer disk, the translucent film has a problem, since it is formed of material including gold (Au) and silicon (Si). This is because, although conventional translucent film can serve as a translucent film for a red laser beam adopted by current DVDs, the reflectivity of the conventional translucent film is too high or too low with respect to a blue laser beam adopted by next-generation DVDs. Thus, they are not suitable for the next-generation DVDs.

In view of the above, in a technique disclosed in Jpn. Pat. Appln. KOKAI Publication No. 9-293270, sulfide (ZnS) is added to both two reflection films, in addition to metal films, to thereby provide a dual-layer disk in which even when a blue laser beam is applied, the amounts of reflected light from both the reflection films are equal each other. However, if the reflection films are processed in such a manner to adjust the amounts of the reflected light, the thickness of each of the reflection films is increased to approximately 60 to 80 nm.

This will give rise to the following problem, if it is applied to the next-generation disks:

Each of the next-generation disks has pits each having a depth of 70 nm and a width of 250 nm. Thus, unless especially a layer L1 (i.e., a reflection film on a deep side), where pits concave as viewed side-on are formed, is further thinned, the pit having the smallest width is filled with part of the film, thus worsening the quality of a reproduction signal.

As mentioned above, in the case of using reflection films in each of which a dielectric layer is stacked on a metal layer in order to achieve a dual-layer disk in which the amounts of light reflected from both the reflection films are equal to each other with respect to a blue laser beam, the thickness of each of the reflection films is approximately 60 to 80 nm, as a result of which pits of the layer 1 (the deep side) which are concave as viewed side-on are filled with part of the film, thus worsening the quality of a reproduction signal.

### BRIEF SUMMARY OF THE INVENTION

An optical disk according to an embodiment of the present invention comprises: a first substrate having a surface which is formed to have first pits representing information, and on which a reflection film is formed; a second substrate having a surface which is formed to have second pits representing information and differing from the first pits, and on which a translucent film is formed of silver or silver alloy containing silver as a main ingredient; and an intermediate layer which is light-transmissive. The reflection film and the translucent film are located opposite to each other, and the intermediate layer fills a gap between the reflection film and the translucent film.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view taken along a circumferential direction of a dual-layer optical disk.

FIG. 2 is a view showing a flow of steps for manufacturing the optical disk.

FIGS. 3A and 3B are views showing waveforms of reproduction signals of a dual-layer optical disk according to an embodiment of the present invention.

### DETAILED DESCRIPTION OF THE INVENTION

An embodiment of the present invention will be explained with the accompanying drawings.

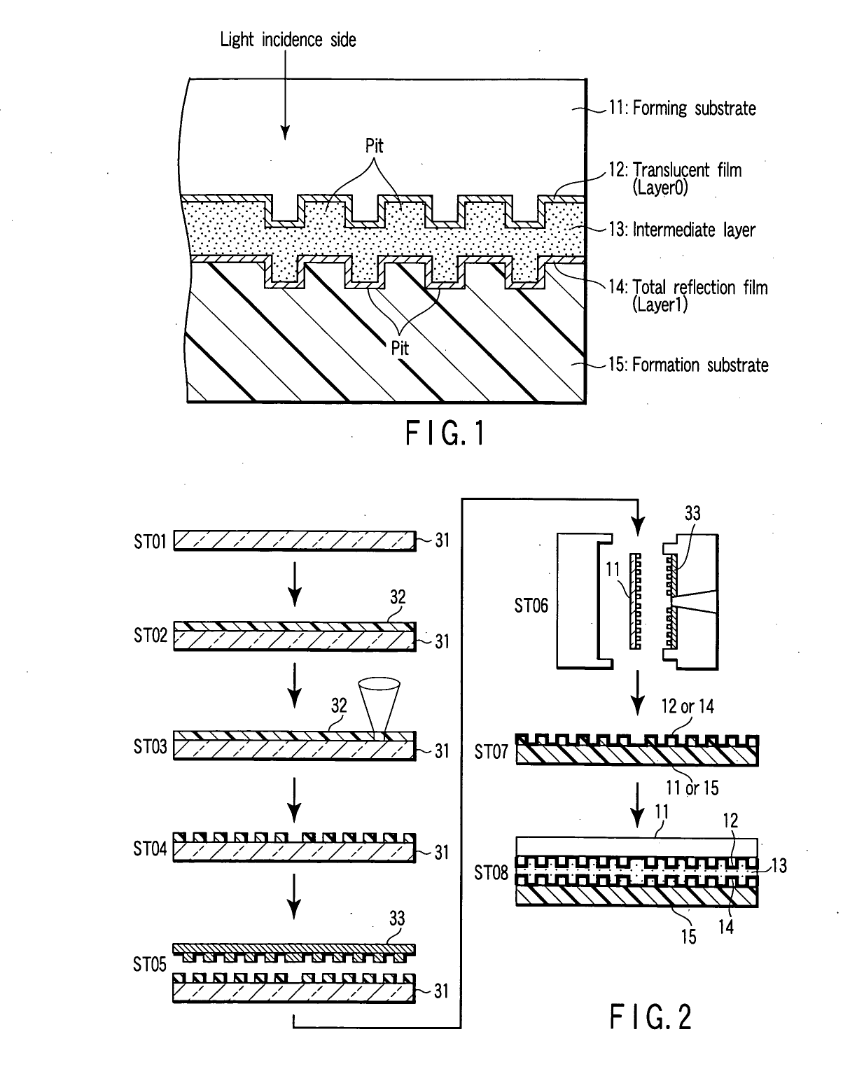

In general, a dual-layer optical disk has such a structure as shown in FIG. 1, and includes a translucent film 12 (layer 0) and a total reflection film 14 (layer 1). The translucent film 12 is a layer formed on a light incidence side on which light is to be incident, and the total reflection film 14 is formed deeper than the translucent layer 12. A signal pattern (information) is transferred as pits on two formation substrates 11 and 15 formed of light-transmissive resin such as polycarbonate. The two formation substrates 11 and 15 are bonded to each other, with an intermediate layer 13 interposed therebetween, and the intermediate layer 13 is formed of, e.g., an ultraviolet curing resin. Generally, different information is recorded on the substrates 11 and 15, respectively. Thus, needless to say, arrangement of the bits on the substrate 11 differs from that of the bits on the substrate 15.

A disk according to the embodiment of the present invention is a disk-ROM which has a diameter of 120 mm and a thickness of 1.2 mm (which is the total thickness of two substrates bonded together and each having a thickness of 0.6 mm). However, the present invention is not limited to the above embodiment, and can be applied to a dual-layer optical disk in which a transparent cover layer having a thickness of 0.1 mm is provided on a substrate having a thickness of 1.1 mm.

In the embodiment of the present invention, it is supposed as an example that light for reproduction is blue light having a wavelength of approximately 400 nm, each of pits of a recording pattern has a depth of 70 nm and a width of 250 nm, and an intermediate layer has a thickness of 20 μm. Also, it should be noted that the light, the pits and the intermediate layer are not limited to the above condition. The disk may be a disk which allows information to be reproduced with red light or light having a wavelength differing from those of blue light and red light. The recording pattern may be more minutely formed. The intermediate layer may have a thickness of approximately 15 μm or 25 μm.

A method for manufacturing a dual-layer optical disk and an apparatus for manufacturing the same will be explained with reference to FIG. 2.

First, a glass (or silicon) substrate 31 having a surface which is ground and cleaned is used as a base substrate (STO). The surface of the base substrate is coated with photoresist 32 (ST02), and is exposed to a laser beam or an electron beam, thereby recording information (ST03). Then, the exposed base substrate is developed, thereby forming pits which are concave as viewed side-on (ST04). The base substrate is subjected to plating processing, thereby forming a stamper 33 (which is generally formed of nickel) (STOS). Then, injection molding is carried out by using the stamper 33 as a molding, thereby forming a formation substrate 11 of resin (generally, polycarbonate) (ST06).

The above method is applied to formation of two formation substrates having recording patterns of a layer 0 and layer 1, respectively. A translucent film 12 is formed on a side of the layer 0 and a total reflection film 14 is formed a side of on the layer 1, by a magnetron sputtering method or the like (ST07). Thereafter, the two formation substrates are bonded to each other by an ultraviolet curing type adhesive agent having a predetermined thickness (ST08), thereby forming a dual-layer optical disk. The ultraviolet curing type adhesive agent serves as an intermediate layer 13. It should be noted that an apparatus for manufacturing the above dual-layer optical disk includes processing sections for carrying out the steps shown in FIG. 2.

In an optical disk which allows data to be reproduced with red light, such as a conventional DVD, gold (Au) and silicon (Si or another compound) are used as the translucent film used in step ST07. However, with respect to blue light, the reflectivity of the conventional translucent film is too high or too low. Thus, they are not suitable as the material of the translucent film of each of next-generation optical disks. In view of this point, in, e.g., Jpn. Pat. Appln. KOKAI Publication No. 9-293270 mentioned above, each of translucent and total reflection films (reflection films) is formed by stacking a metal film and a dielectric film (e.g., zinc sulfide (Zns)) together, in order to adjust the reflectivities of the reflection films with respect to blue light.

However, if the reflectivity is adjusted in such a manner, the translucent and total reflection films cannot be applied to minute pits in the next-generation optical disk in which the total thickness of films is 60 to 80 nm, for the following reason.

The pits representing information on the layer 1 are concave with respect to a light incidence side (optical pickup side), and the next-generation optical disk has pits each having a depth of approximately 70 nm and a width of approximately 250 nm. Thus, when a film is formed to have a thickness of 60 to 80 nm, the smallest pit of a layer 1 is filled with part of the film, and greatly degrading a reproduction signal.

As shown in FIG. 1, with respect to a light incidence side, pits representing information on the layer 0 are convex, and those on the layer 1 are concave. Thus, in a next-generation high-density optical disk which allows information to be reproduced with blue light, it is preferable that the thickness of the total reflection film of the layer 1 be-set to be as small as possible. In view of mass production, for example, aluminum (Al) is suitable as the material of the total reflection film. On the other hand, when Al is applied as the material of the translucent film of the layer 0, the optimal thickness of the translucent film formed of AL is approximately 5 nm, i.e., it is very small, and the speed at which the translucent film is formed is extremely high, thus, the thickness of the film cannot stably or precisely be controlled. Unevenness in the thickness of the translucent films formed of Al causes of unevenness in the reflectivity of the films. In such a manner, Al is not suitable as the material of the translucent film of the layer 0. Accordingly, silver (Ag) is used as the material of the translucent film of the layer 0, since it enables film formation to be stably carried out.

In the embodiment of the present invention, Al having a thickness of 20 to 40 nm is used as the material of the total reflection film of the layer 1, and Ag having a thickness of 10 to 30 nm is used as the material of the translucent film of the layer 0. Thereby, the amount of light reflected from the layer 1 and that from the layer 0 are equalized to each other, as a result of which the pits are not filled with part of the film, and a reproduction signal having a good waveform can be obtained. At this time, the reflectivity of the layer 0 with respect to a blue laser beam falls within the range of 18 to 32%, which is an appropriate value for the next-generation DVDs. It should be noted that in order to improve the corrosion-resistant characteristics of a translucent layer to be formed, silver alloy may be formed by mixing Ag with a very small amount of additive (such as palladium (Pd) or copper (Cu)), which is set so as not to change optical characteristics of the translucent layer. Furthermore, if the productivity of disks is not considered, any of nickel, nickel alloy, chromium, chromium alloy and nickel-chromium alloy may be used as the material of the layer 0.

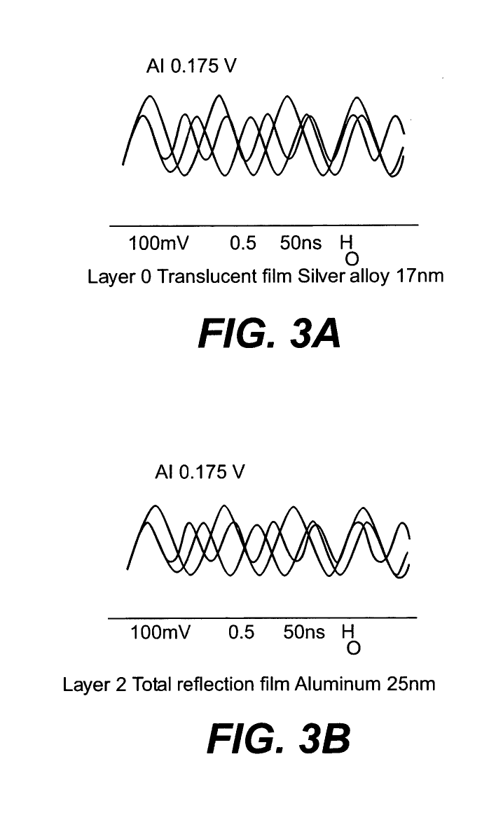

FIGS. 3A and 3B show the waveform of an information reproduction signal of a dual-layer optical disk having a capacity of 15 GB in each layer (the total capacity of the disk is 30 GB) in which a translucent film of a layer 0 is formed of silver alloy having a thickness of 17 nm, and a total reflection film of a layer 1 is formed of aluminum having a thickness of 25 nm. FIG. 3A shows the waveform of a reproduction signal of the layer 0, and FIG. 3B shows the waveform of a reproduction signal of the layer 1. The intensity of the reproduction signal from the layer 0 is substantially equal to that of the reproduction signal from the layer 1, as a result of which the reproduction signal of the optical disk has a good quality.

In the structure of the optical disk according to the present invention, the reflectivity is adjusted by using a metal film only, without using a dielectric such as ZnS, unlike a conventional method. Thus, according to the present invention, films can be formed at a high speed and a high efficiency.

Additional advantages and modifications will readily occur to those skilled in the art. Therefore, the invention in its broader aspects is not limited to the specific details and representative embodiments shown and described herein. Accordingly, various modifications may be made without departing from the sprit or scope of the general inventive concept as defined by the appended claims and their equivalents.

What is claimed is:

1. An optical disk comprising:
a first substrate having a surface which is formed to have first pits representing information, and on which a reflection film is formed;
a second substrate having a surface which is formed to have second pits representing information differing from the first pits, and on which a translucent film is formed of one of silver and silver alloy containing silver as a main ingredient; and
an intermediate layer which is light-transmissive,
the reflection film and the translucent film being located opposite to each other, and the intermediate layer filling a gap between the reflection film and the translucent film.

2. The optical disk according to claim 1, wherein the reflection film on the first substrate is formed of aluminum.

3. The optical disk according to claim 1, wherein the translucent film on the second substrate has a thickness of 10 to 30 nm.

4. The optical disk according to claim 2, wherein the reflection film on the first substrate, which is formed of aluminum, has a thickness of 20 to 40 nm.

5. A method for manufacturing an optical disk, comprising:
forming a reflection film of aluminum on a first formation substrate where pits representing information are formed;
forming a translucent film of one of silver and silver alloy containing silver as a main ingredient, on a second formation substrate where pits representing information are formed; and
opposing the reflection film and the translucent film to each other, and bonding the first and second formation substrates to each other by using an ultraviolet curing type adhesive agent.

6. The method according to claim 5, wherein the reflection film on the first formation substrate has a thickness of 20 to 40 nm.

7. The method according to claim 5, wherein the translucent film on the second formation substrate has a thickness of 10 to 30 nm.

8. An apparatus for manufacturing an optical disk, comprising:
a first forming section configured to form a reflection film of aluminum on a first formation substrate where pits representing information are formed;
a second forming section configured to form a translucent film of one of sliver and silver alloy containing silver as a main ingredient, on a second formation substrate which is light-transmissive and on which pits representing information are formed; and
opposing the reflection film and the translucent film to each other, and bonding the first and second formation substrates to each other by an ultraviolet curing type adhesive agent.
